(19) United States
(12) Patent Application Publication
(10) Pub. No.: US 2016/0034927 A1
(43) Pub. Date: Feb. 4, 2016

(54) Customer Relations Intelligence

(71) Applicant: HUMANIX DATA REALIZATION LTD, Yokneam (IL)

(72) Inventor: Avraham Grushka, Tel Aviv (IL)

(21) Appl. No.: 14/774,295

(22) PCT Filed: Mar. 26, 2014
(86) PCT No.: PCT/IB2014/060172

§ 371 Date: Sep. 10, 2015

Related U.S. Application Data
(60) Provisional application No. 61/805,942, filed on Mar. 28, 2013.

(51) Int. Cl. G06Q 30/02

(52) U.S. Cl. CPC G06Q 30/0202

(57) ABSTRACT

A system and method for customer true understanding based on behavioral economics, comprising: retrieving parameters from an organization's data sources, the parameters including historical operations of the organization's clients; providing a dependent variable indicating consumer behavior and its operational definition; creating a random sample of the retrieved parameters; selecting cognitive heuristics and biases that may be tested using the sample parameters; partitioning the selected heuristics into clusters wherein each cluster is assigned a grade; assigning psychological attributes to clusters; testing the influence of each psychological attributes on the dependent variable; scoring the attributes per customer; and calculating the value of a super variable by a weighted sum of the attributes.

### FIELD OF INVENTION

The current invention relates to customer behavior, marketing and sales intelligence in general, and specifically to a method of evaluating and making decisions based upon customer relations intelligence.

### BACKGROUND

A conventional approach used today is that of various Business Intelligence (BI) systems and techniques, which have the underlying assumption that people are rational, consistent and that they strive to maximize their profit. A major shortcoming of these systems is that they rely upon this traditional economic theory, meaning that consumers consistently behave rationally. As a result, these systems give solutions and output that do not reflect a true familiarity with the customer; the ability to forecast is not good—usually not in real time—and the results of such systems are strongly dependent on the system operator's capabilities.

Today there is near-universal agreement between academia and industrial business—marketing people that solutions based upon traditional BI are limited in effectiveness and represent a “glass ceiling”.

An up-and-coming trend in university and industrial business-marketing circles is that of behavioral economics. Behavioral economics is a an innovative trend which integrates elements of psychology, economics, sociology, game theory, and neurology to understand the behavior and method of decision making under uncertainty, of a person in the business world. This is in fact the method of the future to accurately analyze motivations, desires, intentions and the decision making process of a person in the business world. Behavioral economics is based on assumptions which are opposite those of BI, meaning people are not rational, they are not consistent, and they do not always strive to maximize their profits. Among the leaders of this approach are well-known and respected scientists including, but not limited to:
Professor Daniel Kahneman (psychologist and winner of the 2002 Nobel Memorial Prize in Economic Sciences for his work in prospect theory; known for his work on the psychology of judgment and decision-making, behavioral economics and hedonic psychology);
The late Professor Amos Natan Tversky (a cognitive and mathematical psychologist; pioneer of cognitive science, who worked with Daniel Kahneman to develop prospect theory, which aims to explain irrational human economic choices, which is considered one of the seminal works of behavioral economics);
Professor Vernon Lomax Smith (professor of economics at Chapman University's Argyros School of Business and Economics and School of Law in Orange, Calif.; a research scholar at George Mason University Interdisciplinary Center for Economic Science; a Fellow of the Mercatus Center, Arlington, Va.; and shared the 2002 Nobel Memorial Prize in Economic Sciences with Daniel Kahneman);
Professor Alvin Elliot Roth (visiting professor at Stanford University and George Gund Professor of Economics and Business Administration at Harvard Business School; having made significant contributions to the fields of game theory, market design and experimental economics, and known for his emphasis on applying his economic theory to solutions for “real-world” problems; and in won the Nobel Memorial Prize in Economic Sciences for the theory of “stable allocations and the practice of market design”);
Professor Dan Arieli (professor of psychology and behavioral economics; teaching at Duke University; founder of The Center for Advanced Hindsight; author of Predictably Irrational and The Upside of Irrationality, both of which became New York Times best sellers);
Professor Richard H. Thaler (American economist and the Ralph and Dorothy Keller Distinguished Service Professor of Behavioral Science and Economics at the University of Chicago Booth School of Business; perhaps best known as a theorist in behavioral finance, and for his collaboration with Daniel Kahneman and others in further defining that field);
Professor Ernst Fehr (Professor of Microeconomics and Experimental Economic Research and chairman of the Department of Economics at the University of Zurich, Switzerland; whose research covers the areas of the evolution of human cooperation and sociality, in particular fairness, reciprocity and bounded rationality; and also well known for his important contributions to the new field of neuroeconomics, as well as to behavioral finance and experimental economics).

Most organizations today know their customers based upon after-the-fact analyses of consumer behavior, without any understanding of real-time customer motivation and with limited forecasting ability, as described further herein below.

Today, the problems noted above are addressed primarily in two methods:

1. BI and Analytical CRM Systems
BI systems serve to analyze customer activity/operational/business patterns of activity in an overall fashion, with no ability to forecast. The systems are semi automated, employing a non-continuous frequency of sampling and they are dependent on the software operational capabilities of professional staff and interpretation of results. As a result, the timeliness and value of such results are limited. Analytical CRM systems—in contradistinction to the BI systems noted hereinabove—include automated forecasting algorithms. However, they have limited effectiveness due to their being based upon cluster/superficial semantic analyses without any real understanding of the complexity of customer motivations and desires.

2. Customer/Market Research
Such research is performed by external research companies or by in house analysis departments using methods based upon small samples and techniques such as: focus groups, questionnaires and interviews. Results obtained by these techniques are applicable to the entire customer population, meaning there is neither analysis nor recognition of each individual customer. A process to address the individual is time consuming and cumbersome—yielding results that frequently are not timely.

Continuous and automated BIG DATA analysis, based on behavioral economics and having consumer behavioral forecasting abilities is not available today with any system.

There is therefore a widespread need in the marketplace to combine BI and behavioral economics methods and to better understand consumer behavior in real time while using effective management tools to enable company management to make decisions and to effectively give instructions to sales and service staff.

### SUMMARY

According to a first aspect of the present invention there is provided a method of customer true understanding based on behavioral economics, comprising: retrieving parameters from an organization's data sources, the parameters including historical operations of the organization's clients; providing a dependent variable indicating consumer behavior and its operational definition; creating a random sample of the retrieved parameters; selecting cognitive heuristics and biases that may be tested using the sample parameters; partitioning the selected heuristics into clusters wherein each cluster is assigned a grade; assigning psychological attributes to clusters; testing the influence of each psychological attributes on the dependent variable; scoring the attributes per customer; and calculating the value of a super variable by a weighted sum of the attributes.

The retrieved parameters may comprise at least one of data and meta-data.

Creating a random sample of the retrieved parameters may comprise cleansing the parameters and selecting the cleansed parameters having significance in a regression model or being appropriate for a statistical testing.

Assigning a grade to each cluster may comprise summing standardized Z-scores of the cluster's parameters.

Testing the influence of each psychological attributes on the dependent variable may comprise calculating a partial correlation between the cluster's grade and the entries in the relevant row in a psychological constructs table.

Testing the influence of each psychological attributes on the dependent variable may comprise performing factor analysis and performing at least one of a t-test and a regression analysis on the remaining psychological constructs.

Scoring the attributes per customer may comprise standardizing the customer's parameters and multiplying them by a weight comprising the grade of the respective cluster.

In another aspect of the present invention there is provided a system for customer true understanding based on behavioral economics, comprising: an organizational server comprising a customers' data base; and a system server communicating bi-directionally with the organizational server, the system server running a server application configured to communicate with the organizational server's data base to extract historic customer behavior quantitative parameters and return feedback of customer analysis. The server application may comprise: a history analysis module configured to cleanse and filter quantitative parameters imported from the organizational database; a segmentation module configured to categorize the parameters according to cognitive biases and heuristics; a customer attributes module configured to translate the cognitive biases and heuristics to psychological variables; and a reports module configured to create clusters of super-variables which comprise variables found in previous stages.

The reports module may further be configured to present visual results and recommendations.

The recommendations may be per customer and may be stored in the customers' data base.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a graphic representation of some variables and their derivatives, in accordance with an embodiment of the current invention;

FIG. 2 is a schematic module-block diagram of part of the CTU in accordance with an embodiment of the current invention;

FIG. 3 is a block diagram showing the main modules of the main CTU application, in accordance with embodiments of the current invention;

FIGS. 4A and 4B are a flowchart showing steps of a method of customer relations intelligence in accordance with embodiments of the current invention; and

FIG. 5 is a psychological constructs table.

### DETAILED DESCRIPTION OF THE INVENTION

In the specification and claims which follow, the term “customer” is intended to have a wide meaning, including “consumer”, “client”, “user” and other individual and organizational customers. While the discussion below deals mainly with consumers, other customers—as defined above—are equally applicable.

In addition, the term organization may refer to a physical organization or a virtual/online organization (for example: E-commerce).

In general, one embodiment of the current invention is a SaaS organizational software, which processes and transforms existing data in customer contact systems vis-a-vis an organization/product to create a behavioral psychological profile of each customer.

Embodiments of the current invention include an innovative customer true understanding (CTU) system, based on a behavioral economics approach, having on-line/real time automated analyses and BIG DATA processing, as known in the art with Customer relationship management (CRM), Interactive voice response (IVR), and billing systems. One output of the CTU system is an exact profile of each customer and real segmentation in organizations having many customers. The profile output is based upon variables from the field of behavioral economics and enables individual customer recognition and behavior forecasting.

Examples of variables include, but are not limited to: pragmatic collaborations; emotional collaborations; need for a framework; impulsiveness; long term planning; purchasing intentions; churn probability; loyalty; and customer/product matching.

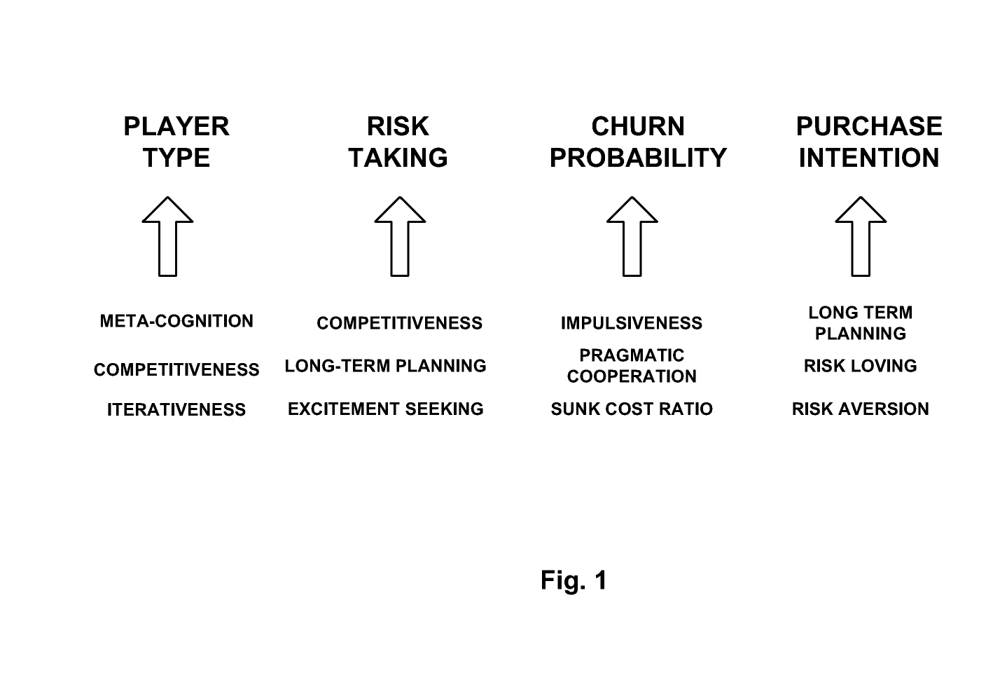

FIG. 1 is a graphic representation of some of the abovementioned variables and their derivatives, in accordance with an embodiment of the current invention.

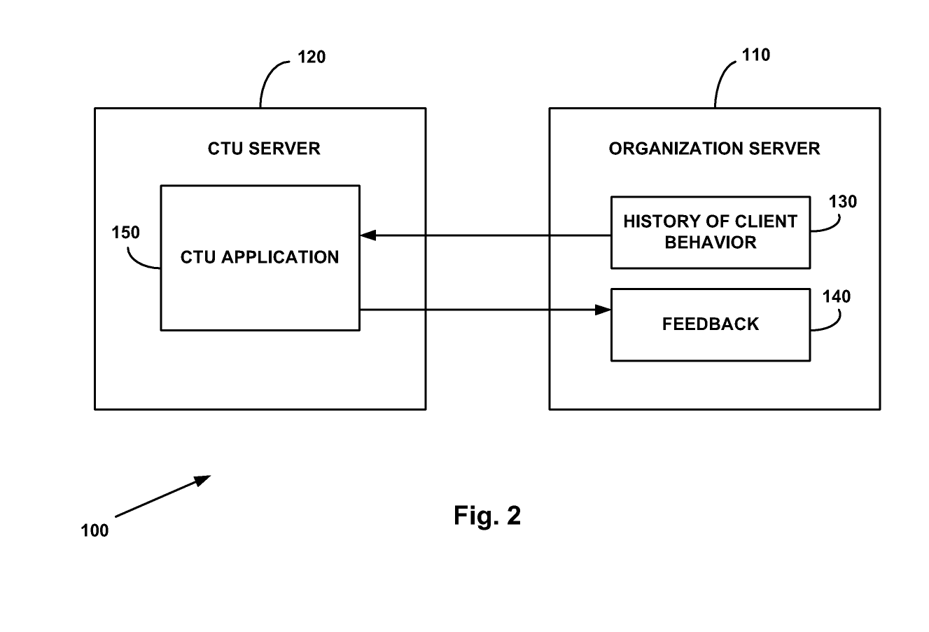

FIG. 2 is a schematic module-block diagram of the system 100 according to the current invention, comprising an organizational server 110 communicating bi-directionally with a CTU server 120. The CTU server runs a CTU application 150 which communicates with the organizational server's databases (130, 140) to extract historic customer behavior quantitative parameters and return feedback of customer analysis.

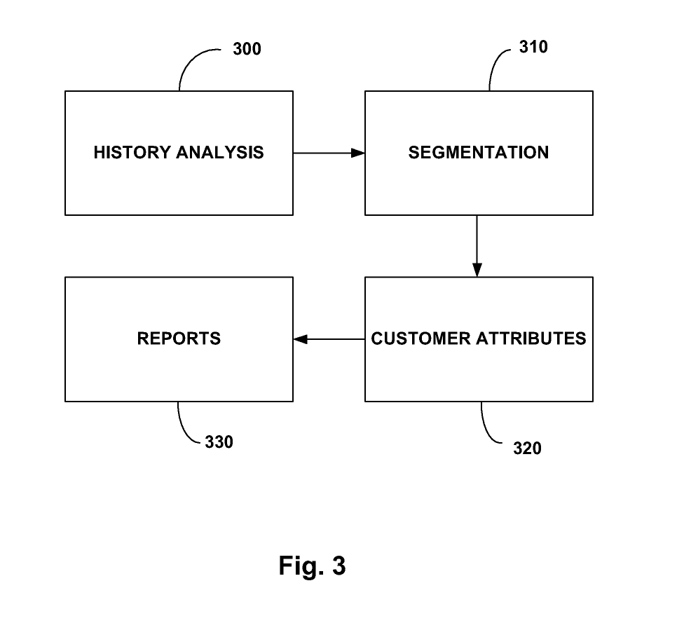

FIG. 3 is a block diagram showing the main modules of the main CTU application, in accordance with embodiments of the current invention:

History analysis module—in charge of cleansing and filtering the quantitative parameters imported from the organizational databases, leaving only the relevant data useful for analysis and forecasting, using data mining procedures and patterns validation.

More specifically, relevant parameters are imported from the organizational system server (from existing data) with the data being “cleansed” and coded in a 1:1 value manner. In other words, the system receives the data with no customer identifying details. Following processing, the organization knows how to associate specific customer results according to the 1:1 coding it has received. This process is performed by a scheduler on a time (e.g. daily) basis by an automatic crawler which scans the data, thereby yielding up-to-date results.

Segmentation module—in charge of categorizing the numeric parameters according to cognitive biases and heuristics, using various statistic methods.

Customer attributes module—in this module the cognitive biases and heuristics are translated to psychological variables using indices based on scientific literature/thousands of researches and after which, double checking using statistical analyses and game theory techniques—empirical checking to ensure the findings are effective and are valid forecasts.

Reports module—this module creates clusters of super-variables (such as: churn probability, purchase intention, etc.) which comprise variables found in previous stages and filtering of variables that were found to be irrelevant to any cluster. This process is intended to increase results validity.

At the end of the process, there are two major outputs (that can be used for a sophisticated drill down):
1. Detailed strategic managers' reports, which display segmentation and real customer behavioral patterns, motivations and tendencies;
2. A dashboard, on an operational level, for service and sales representatives. The customer profile is displayed for the representative as a supporting decision tool for use when he interacts with the customer.

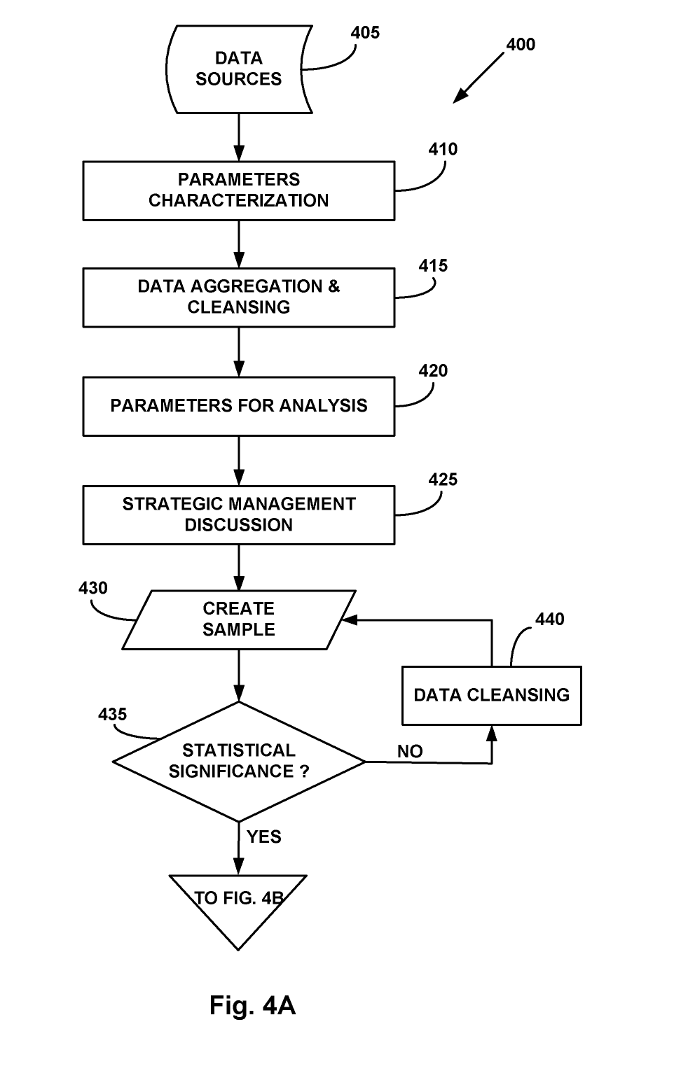

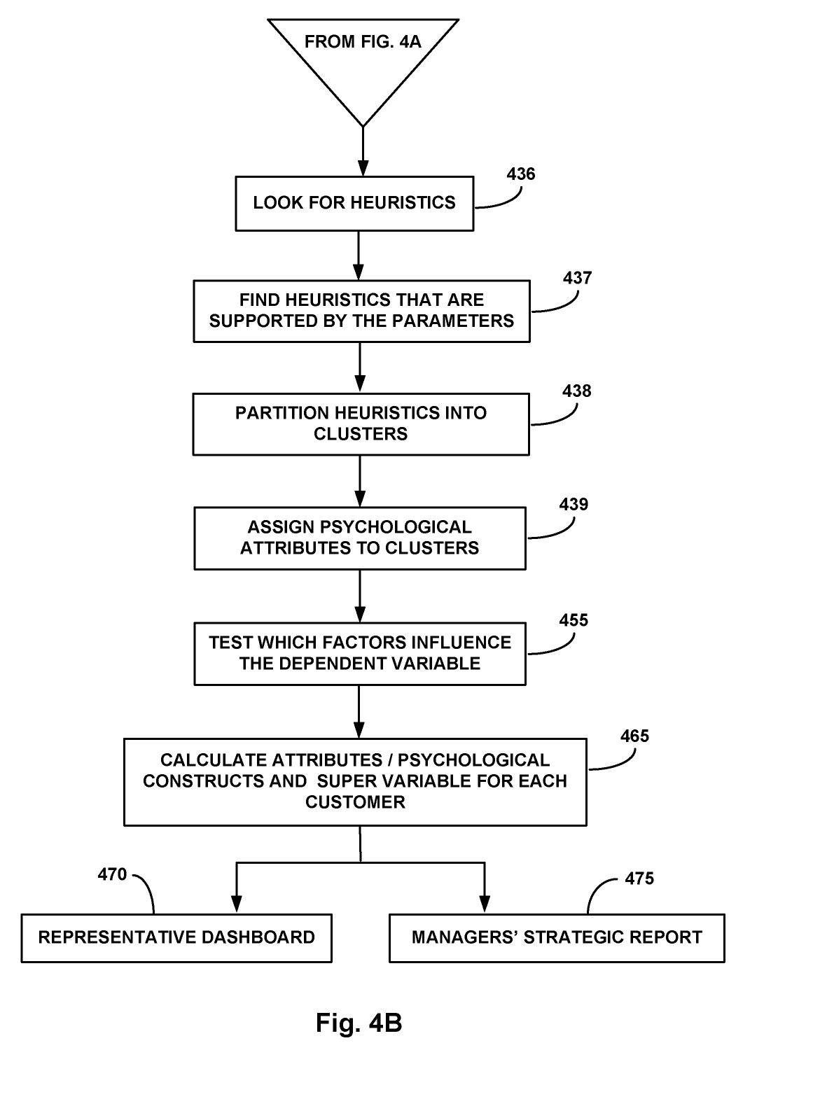

Reference is currently made to the flowcharts of FIGS. 4A and 4B, showing steps of a method of customer relations intelligence 400 in accordance with embodiments of the current invention.

In step 405, data and meta-data from the organization's data sources is communicated to the CTU server. The data includes historical behavior (operations) of the various clients.

The transfer may be done by web service/API request or by manual uploading of one or more data files.

The organizational data sources may be, for example, Customer relationship management CRM (For example: SAP CRM, Microsoft Dynamics, Oracle CRM, Salesforce, Amdocs CRM), Interactive voice response IVR (For example: Genesys, Centcom, Avaya), Billing (For example: Amdocs, Oracle, Convregys), Polls or Data Warehouses.

The data is preferably raw data (facts), where each customer's operation occupies at least one full row.

According to embodiments of the invention, if raw data is unavailable, the input may comprise semi-raw data aggregated per each customer. For example, the use of ‘Data’ of a cellular service may be depicted to each user in the following manner:

Raw Data (Facts):

| Customers'_key_num | Date | Data_Amount_used (MB) | Data_Balance |
|---|---|---|---|
| 123 | 22.12.13 | 0.32 | 3 |
| 123 | 23.12.13 | 0.13 | 1 |
| 123 | 26.12.13 | 1.15 | 8 |

Alternatively, Semi Raw Data (Aggregated):

| Customers'_key_num | Date | Data_Amount_used_sum (MB) | Data_Balance _sum |
|---|---|---|---|
| 123 | Dec 13 | 14.47 | 12 |

In step 410 an operator characterizes the nature of each parameter in the data table(s). This operation is done once per data base. Each data item may be identified by a number of identifiers. For example:

Data type—key/date/hour/money/amount_used/address/area_code/phone number/product key/service_sale_call/service_sale_data/internet_use.

Data format—date/string/numeric.

Data measure—ordinal/nominal/scale.

In step 415, each parameter/file is aggregated (the break variable is the customers' key identifier) by means of mean/sum/moving_average/count/std/variance/date/min/max etc.

After the aggregation new parameters are composed by computing simple mathematical functions between the aggregated parameters (arpo_SMS=seniority (date aggregated)*interactions(count sms aggregated)/balance (sum aggregated)).

Following this step, the number of parameters is increased.

For example:

| Customers'_key_num | Activated_Date | seniority | sms_Balance_mean | Sms_balance_sum | Sms_interactions_sum | Arpo_sms |
|---|---|---|---|---|---|---|
| 90 | 10.10.12 | 461 | 54.2 | 591 | 1319 | 1028 |
| 180 | 23.03.13 | 52 | 82.0 | 150 | 491 | 160 |
| 210 | 16.12.12 | 414 | 115 | 662 | 1693 | 1058 |

Each Customer has 6 parameters after transformation:

Activated_Date, seniority, sms_Balance_mean, Sms_balance_sum, Sms_interactions_sum and Arpo_sms.

While originally the customer had 2 parameters:

Activated Date and Sms_balance_after_use

In the following process, the aggregated and new parameters in the different files (where each customer is a row in the database) are merged into one file that contains all the parameters.

The merge procedure may be done by a ‘merging by variables’ method such as known in the art, where the key is the customers' identifier.

The next procedure is cleansing (parsing, anomalies, correction and standardization): each row (customer) is tested for outliers/missing data and if found ‘true’ it is discarded (marked as N/A). The same is done for each column (parameter): if it has more than 35% of missing data or the variance is lower than 1 —the parameter is discarded (see http://en.wikipedia.org/Data cleansing).

In step 420, the data set of parameters for analysis is created (all the processed data without the discarded cases and parameters).

In step 425 an offline strategic management discussion takes place in order to define mathematically the dependent variable/s (for example, in the pre-paid cell phone industry, the operational definition of the dependent variable “purchase” may be defined as “charging your account in the sum of over $50”.)

In step 430, a dataset is created, which is a 1.5%, randomized sample of the previous data set (IF N<1000 then stop process).

In steps 435 and 440 a regression analysis is done to determine which of the sample parameters may be used for the model. All the parameters in the dataset are assigned into the model as independent variables and the dependent variable is the one that was defined in the strategic meeting. If the dependent variable is categorical then the regression model is ‘logit’ and if it is continuous then the model is ‘simple linear’.

If the R²>0.25 and sig. (α<0.05) of the model, then it is fit to be a valid data model, and if βn sig. <0.05 (t=b/se(b) and >2) then parameter n is included in the cleansed data model.

In step 436 the process looks (according to literature indices) for cognitive heuristics and biases that may be tested using the cleansed model parameters, such as:
Hot-hand fallacy—HHF
Conjunction fallacy—CF
Base rate fallacy—BRF
Confirmation bias—CB
Availability-heuristic—AH
Representativeness heuristic—RH
Pseudocertainty effect PE
Status quo bias—SQB
Zero-risk bias—ZRB
Zero-sum heuristic—ZSH
Anchoring—ANCH
Endowment effect—EE
regressive bias—RB
Neglect of probability—NOP
Frequency illusion—FE
Clustering illusion—CI
Loss aversion—LA
Overconfidence effect—OE
Framing effect—FE
Gambler's fallacy—GF
Ambiguity effect—AE
Backfire effect—BE
Denomination effect—DE
Money illusion—MI

In step 437 the process double-checks whether the same parameters actually belong to the heuristics. This is done by:
a. Calculating correlation between the various parameters by production of a correlations Pearson coefficient matrix (n×n) of all the combinations between the parameters.
b. Calculating partial correlation between the correlation of (a) and correlations coefficients (heuristics coefficients) controlling the shared heuristic.

The partial correlations that are found to be significant indicate the heuristics that are supported by the actual parameters.

In step 438 the process partitions the selected (supported) heuristics into clusters, using e.g. the k-means method. In the clustering process each created cluster is assigned a grade which is the sum of standardized Z-scores of the cluster's parameters.

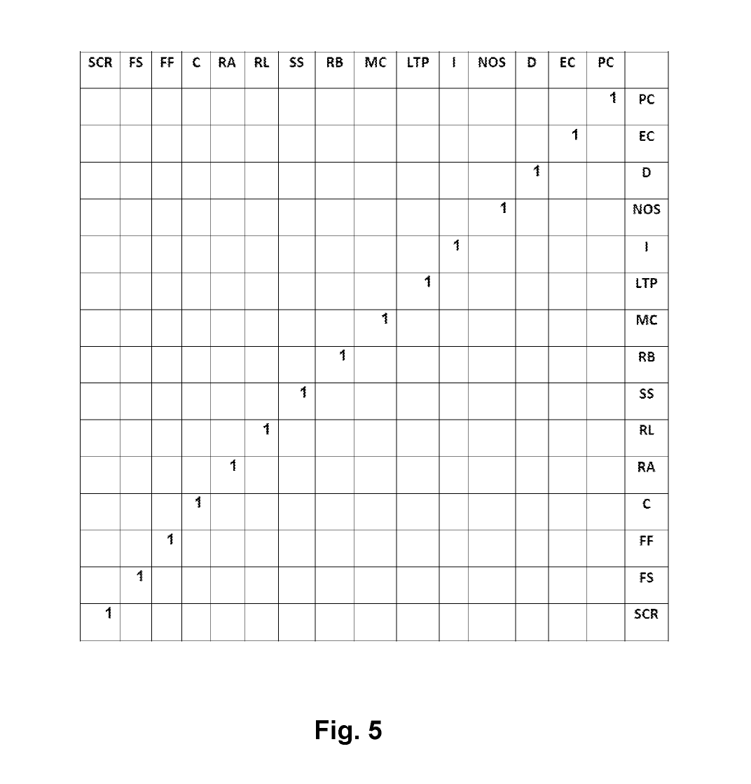

FIG. 5 is a psychological constructs table derived from literature, where:
Pragmatic/Cognitive Cooperation/Empathy—PC
Emotional Cooperation/Empathy—EC
Defection—D
Need of environmental/frame/social support—NOS
Impulsiveness—I
Long term planning/thinking—LTP
Meta-cognition—MC
Repetitive/Iterative behavior—RB
Sensation seeking—SS
Risk loving/seeking—RL
Risk aversion—RA
Competitiveness—C
Fear of failure—FF
Fear of success—FS
Sunk cost ratio—SCR

In step 439 the process checks the influence of the cluster on each given psychological construct (see psychological constructs table) by calculating the partial correlation between the cluster's grade and the entries in the relevant row in the psychological constructs table. Only the construct(s) having produced significance is selected and the cluster is named thereafter (psychological attributes). The psychological attributes are assigned the cluster grades as initial weights.

In step 455 the attributes that were found in the previous step are being tested empirically (if they are manifested in the data) to test which factors (constructs) influence the dependent variable (i.e. whether they participate in creating the super variable, which is the tested behavior of the customer). The test may be done, for example, using factor analysis, as follows:
a. Use the coefficients (constructs' weights) as factors to factor analysis method Principal Component Analysis (PCA).
b. Constructs that get value higher than 1 (delta)—are assigned a valid structure, the others are discarded.
c. Perform regression analysis (and t-test if possible) between the independent variables and the significant psychological constructs (If the data model's R²>0.25 and sig. (α<0.05) and βn sig. <0.05 (t=b/se(b) and >2) then construct n is included in the model, or t-test for independent variables according to classification of 0 and 1—below average: 0 above average: 1 to each psychological construct).
d. If both methods were used—choose the method that predicts more n's as sig predictors (β or sig t-test for independent variables).

In step 465 a scoring procedure is performed for the attributes that were found in the previous step and for the predicted super variable (that is built out of sum of the attributes), per customer:
a. Attributes scoring per customer: standardize the raw parameters values that are the building blocks of each attribute found in the previous step as being fit to the model, by assigning the parameters the score of the attribute (construct) to which it belongs.
   Multiply each parameter by its score.
   Round the score to a scale of 1 to 9.
b. Super variable scoring per customer: Calculate the super variable value by a weighted sum of the constructs and transform to an integer score of 1 to 9.

In steps 470 and 475 the results are prepared for presentation, e.g. a manager's strategic report and a representative dashboard are created.

The representative's report may include presentation of relevant customers' profiles (optionally graphic) and a personal trend graph predicting the customer's future behavior.

The manager's report may include characteristics and motivation values of each customer and aggregate calculated values predicting customers' future behaviors.

The reports may include verbal individual and/or general recommendations based on the characteristics found.

The system may include means (API) for extracting analyzed data (feedback) to from the reports and integrating it in the organizational systems.

It will be appreciated that the above descriptions are intended only to serve as examples, and that many other embodiments are possible within the scope of the present invention and as defined in the appended claims.

1-12. (canceled)

13. A method of forecasting consumer behavior based on behavioral economics, comprising:
periodically retrieving parameters from an organization's data sources, the parameters including consumer behavior of the organization's clients;
providing a dependent variable indicating consumer behavior and its operational definition;
categorizing the parameters according to cognitive heuristics and biases; and
translating the cognitive heuristics and biases into psychological attributes predicting said indicated consumer behavior.

14. The method of claim 13, wherein said retrieved parameters comprise at least one of data and meta-data.

15. A system for forecasting consumer behavior based on behavioral economics, comprising:
an organizational server comprising a customers' data base; and
a system server communicating bi-directionally with said organizational server, the system server running a server application configured to communicate with the organizational server's data base to:
periodically extract consumer behavior quantitative parameters;
receive a dependent variable indicating consumer behavior and its operational definition;
categorize the parameters according to cognitive heuristics and biases; and
translate the cognitive heuristics and biases into psychological attributes predicting said indicated consumer behavior.

16. The system of claim 15, wherein said server application comprises:
a history analysis module configured to cleanse and filter quantitative parameters imported from the organizational database;
a segmentation module configured to categorize the parameters according to cognitive biases and heuristics;
a customer attributes module configured to translate the cognitive biases and heuristics to psychological variables; and
a reports module configured to create clusters of super-variables which comprise variables found in previous stages.

17. The system of claim 16, wherein said reports module is further configured to present visual results and recommendations.

18. The system of claim 17, wherein said recommendations are per customer.

19. The system of claim 18, wherein said recommendations are stored in said customers' data base.

20. The method of claim 13, further comprising:
creating a random sample of clients.

21. The method of claim 20, wherein said categorizing the parameters according to cognitive heuristics and biases comprises:
selecting cognitive heuristics and biases that may be tested using the sample parameters; and
partitioning the selected heuristics into clusters, wherein each cluster is assigned a grade.

22. The method of claim 21, wherein said translating the cognitive heuristics and biases into psychological attributes comprises:
assigning psychological attributes to said clusters;
testing the influence of each psychological attribute on the dependent variable;
scoring the attributes per consumer; and
calculating the value of a super variable by a weighted sum of the attributes.

23. The method of claim 20, wherein said creating a random sample comprises cleansing the parameters and selecting the cleansed parameters having significance in a regression model or being appropriate for a statistical testing.

24. The method of claim 21, wherein said assigning a grade to each cluster comprises summing of standardized Z-scores of the cluster's parameters.

25. The method of claim 22, wherein said testing the influence of each psychological attributes on the dependent variable comprises calculating a partial correlation between the cluster's grade and the entries in the relevant row in a psychological constructs table.

26. The method of claim 22, wherein said testing the influence of each psychological attributes on the dependent variable comprises performing factor analysis and performing at least one of a t-test and a regression analysis on the remaining psychological constructs.

27. The method of claim 22, wherein said scoring the attributes per customer comprises standardizing the customer's parameters and multiplying them by a weight comprising the grade of the respective cluster.
